(19) United States
(12) Patent Application Publication
(10) Pub. No.: US 2009/0110624 A1
(43) Pub. Date: Apr. 30, 2009

(54) Processes for Producing Phosphates

(75) Inventors: Xiangsheng S. Meng, Chanhassen, MN (US); Paraskevas Tsobanakis, Inver Grove Heights, MN (US); Charles Sanderson, Minneapolis, MN (US); Ian C. Purtle, Plymouth, MN (US); Colin G. Weyrauch, Brandon, FL (US)

Correspondence Address: KAGAN BINDER, PLLC, SUITE 200, MAPLE ISLAND BUILDING, 221 MAIN STREET NORTH, STILLWATER, MN, 55082, US

(73) Assignee: CARGILL, INCORPORATED, Wayzata, MN (US)

(21) Appl. No.: 11/921,382

(22) PCT Filed: May 12, 2006
(86) PCT No.: PCT/US2006/018493

§ 371 Date: Dec. 11, 2008

Related U.S. Application Data
(60) Provisional application No. 60/683,042, filed on May 20, 2005.

(51) Int. Cl. C01B 25/28; C01B 25/30

(52) U.S. Cl. 423/302; 423/305

(57) ABSTRACT

There are disclosed methods for producing ammonium, sodium, and/or potassium phosphates that involve reacting phosphate rock with ammonium, sodium and/or potassium hydrogen sulfate.

### FIELD OF THE INVENTION

The present invention relates to processes for producing ammonium phosphate. Several of the process may be used to also produce sodium phosphate, potassium phosphate, or calcium phosphates.

### BACKGROUND OF THE INVENTION

Phosphate rock (Ca₅F(PO₄)₃) is reacted with phosphoric acid to produce monobasic calcium phosphate slurry. The monobasic calcium phosphate slurry is then reacted with sulfuric acid to produce phosphoric acid and dihydrated calcium sulfate (also referred to as gypsum waste). The phosphoric acid is used to produce ammonium phosphate, calcium phosphate, and other phosphate products. In this process, hydrofluoric acid is produced, and, accordingly, sufficient silica must be added to convert the hydrofluoric acid to volatile fluosilicic acid. Thus when phosphoric acid is evaporated up to final concentration, significant quantities of fluosilicic acid evaporate in addition to water. The acidic nature of the fluosilicic acid and hydrofluoric acid allows only the use of single effect evaporators with fluosilicic acid traps, and direct contact condensers. Moreover, the gypsum slurry that contains, one or more, of residual sulfuric, phosphoric, hydrofluoric, fluosilicic acids, and a variety of other impurities, causes handling and environmental problems.

Accordingly, it is desirable to provide processes that produce ammonium, sodium, or potassium phosphates wherein gypsum, hydrofluoric acid, fluosilicic acid and other wastes are reduced.

### SUMMARY OF THE INVENTION

In a first embodiment, the present invention relates to a process for producing ammonium phosphate, sodium phosphate or potassium phosphate. The process involves reacting phosphate rock with ammonium, sodium, or potassium hydrogen sulfate, at any suitable temperature, preferably a temperature of about 20° C. to about 100° C., to produce a slurry comprising calcium phosphates, ammonium, sodium, or potassium sulfate, dihydrated calcium sulfate (gypsum) and calcium fluoride. The slurry is filtered to remove ammonium, sodium, or potassium sulfate from the slurry. The remaining solid comprises calcium phosphates, dihydrated calcium sulfate (gypsum) and calcium fluoride. The solid material is reacted with additional ammonium, sodium, or potassium hydrogen sulfate preferably at a temperature of about 20° C. to about 100° C., whereby calcium phosphates in the solid material are reacted to form mono-ammonium, sodium, or potassium phosphate and dihydrated calcium sulfate. The resultant mono-ammonium, sodium, or potassium phosphate is separated by any means such as, preferably, filtration. It is expected that the mono-ammonium, sodium, or potassium phosphate, will have high purity.

The solids remaining after separation of the mono-ammonium, sodium, or potassium, phosphate comprise mainly dihydrated calcium sulfate (gypsum), may be treated with ammonium, sodium, or potassium carbonate to convert dihydrated calcium sulfate (gypsum) to ammonium, sodium, or potassium sulfate and calcium carbonate. The calcium carbonate is separated, and the remaining ammonium, sodium, or potassium sulfate may be reacted with sulfuric acid to produce ammonium, sodium, or potassium hydrogen sulfate, which may be recycled to the process.

As mentioned above, the process may alternately produce sodium, or potassium phosphate. This is achieved by substituting the use of sodium hydrogen sulfate or potassium hydrogen sulfate, for the ammonium hydrogen sulfate, in the same process.

The ammonium, sodium, and potassium phosphates produced by the embodiment above, may be utilized as produced, or may be used as an intermediate in the production of di-ammonium, sodium, or potassium phosphate or other phosphates, such as calcium phosphates.

In a second embodiment, the present invention relates to another process for producing ammonium phosphate. In this process, phosphate rock (also referred to as fluoroapatite) is reacted with ammonium hydrogen sulfate, at any suitable temperature preferably about 20° C. to about 100° C., to form a slurry comprising calcium phosphates, dihydrated calcium sulfate (gypsum), calcium fluoride, and ammonium sulfate. The ammonium sulfate is separated from the slurry by any conventional means, such as by filtration. The remaining solids, resulting from filtration, is then treated with additional ammonium hydrogen sulfate, at a suitable temperature, preferably about 20° C. to about 100° C., to convert the calcium phosphates to mono-ammonium phosphate and dihydrated calcium sulfate (gypsum). The mono-ammonium phosphate is separated from the solids by any suitable means, preferably by filtration. It is expected that the mono-ammonium phosphate may be used as such, or used as an intermediate in producing di-ammonium phosphate or other phosphates, such as calcium phosphates. It is also expected that the resultant mono-ammonium phosphate will have a high level of purity.

The solids resulting from the filtration, after removal of the mono-ammonium phosphate, which are mainly dihydrated calcium sulfate (gypsum) and calcium fluoride, is then treated with ammonium carbonate to convert the dihydrated calcium sulfate to ammonium sulfate and calcium carbonate. The ammonium sulfate is separated from the solids by any suitable means, preferably by filtration, and thermally decomposed. More particularly, the ammonium sulfate produced in this embodiment, may be subjected to thermal decomposition at any suitable temperature, preferably at a temperature of about 100° C. to about 300° C., to produce ammonium hydrogen sulfate for recycling to the process for reuse. The calcium carbonate is removed as waste.

In a third embodiment, the present invention relates to another process for producing ammonium phosphate, sodium phosphate or potassium phosphate. In this embodiment, phosphate rock is reacted with ammonium, sodium or potassium hydrogen sulfate, at any suitable temperature, preferably at a temperature ranging from about 20° C. to about 100° C., to produce a slurry comprising calcium phosphates, ammonium, sodium, or potassium sulfate, dihydrated calcium sulfate (gypsum), and calcium fluoride. The slurry is reacted with sulfuric acid at any suitable temperature, preferably about 20° C. to about 100° C., whereby the sulfate in the slurry is converted to ammonium, sodium or potassium hydrogen sulfate, and the calcium phosphates are converted by ammonium, sodium, or potassium hydrogen sulfate to mono-ammonium, sodium or potassium phosphate and dihydrated calcium sulfate (gypsum). The mono-ammonium, sodium or potassium phosphate is separated from the solids by any suitable means, preferably by filtration.

The solids remaining after the separation of the mono-ammonium, sodium or potassium phosphate are treated with ammonium, sodium or potassium carbonate to convert the dihydrated calcium sulfate (gypsum) to ammonium, sodium or potassium sulfate and calcium carbonate. The ammonium, sodium or potassium sulfate may be separated from the calcium carbonate, and then reacted with sulfuric acid to produce ammonium, sodium or potassium hydrogen sulfate for recycling to the process for reuse.

The mono-ammonium, sodium or potassium phosphates produced in this embodiment are expected to have a high degree of purity. The mono-ammonium, sodium or potassium phosphate may be used as is or may be used as an intermediate in producing di-ammonium, sodium, or potassium phosphate or other phosphates.

### DETAILED DESCRIPTION OF THE INVENTION

In a first embodiment, the present invention relates to producing ammonium phosphate, sodium phosphate or potassium phosphate. The process involves reacting phosphate rock with ammonium, sodium or potassium hydrogen sulfate, at any suitable temperature, preferably a temperature of about 20° C. to about 100° C., to produce a slurry comprising calcium phosphates, ammonium, sodium or potassium sulfate, dihydrated calcium sulfate (gypsum) and calcium fluoride. The slurry is filtered to remove ammonium, sodium or potassium sulfate from the slurry. The remaining solid comprises calcium phosphates, dihydrated calcium sulfate (gypsum) and calcium fluoride. The solid material is reacted with additional ammonium, sodium, or potassium hydrogen sulfate, preferably at a temperature of about 20° C. to about 100° C., whereby calcium phosphates in the solid material is reacted to form mono-ammonium, sodium, or potassium phosphate and dihydrated calcium sulfate. The resultant mono-ammonium, sodium or potassium phosphate is separated by any means such as, preferably, filtration. It is expected that the mono-ammonium, sodium or potassium phosphate will have a high purity level.

The solids remaining after separation of the mono-ammonium, sodium or potassium phosphate, may be treated with ammonium, sodium or potassium carbonate to convert dihydrated calcium sulfate (gypsum) to ammonium, sodium or potassium sulfate and calcium carbonate. The calcium carbonate is separated and the remaining ammonium, sodium or potassium sulfate may be reacted with sulfuric acid to produce ammonium, sodium, or potassium hydrogen sulfate, which may be recycled to the process.

As mentioned above, the process may alternately produce sodium or potassium phosphate. This is achieved by substituting the use of sodium hydrogen sulfate or potassium hydrogen sulfate, for the ammonium hydrogen sulfate, in the same process.

The ammonium, sodium, and potassium phosphate produced by the embodiment above, may be utilized as produced, or may be used as an intermediate in the production of di-ammonium, sodium, and potassium phosphate or the phosphates.

In a second embodiment, the present invention relates to another process for producing ammonium phosphate. In this process, phosphate rock (also referred to as fluoroapatite) is reacted with ammonium hydrogen sulfate, at any suitable temperature, preferably a temperature of about 20° C. to about 100° C., to form a slurry comprising calcium phosphates, dihydrated calcium sulfate (gypsum), calcium fluoride, and ammonium sulfate. The ammonium sulfate is separated from the slurry by any conventional means, such as by filtration. The remaining solids, resulting from the filtration, is then treated with additional ammonium hydrogen sulfate, at a suitable temperature, preferably about 20° C. to about 100° C., to convert the calcium phosphates to mono-ammonium phosphate and dihydrated calcium sulfate (gypsum). The mono-ammonium sulfate is separated from the solids by any suitable means, preferably by filtration. It is expected that the mono-ammonium phosphate may be used as such, or used as an intermediate in producing di-ammonium phosphate or other phosphates. It is also expected that the resultant mono-ammonium phosphate will have a high level of purity.

The solids resulting from the filtration, after removal of the mono-ammonium phosphate, which are mainly dihydrated calcium sulfate (gypsum) and calcium fluoride, is then treated with ammonium carbonate to convert the dihydrated calcium sulfate to ammonium sulfate and calcium carbonate. The ammonium sulfate is separated from the solids by any suitable means, preferably by filtration, and thermally decomposed. More particularly, the ammonium sulfate produced in this embodiment may be subjected to thermal decomposition at any suitable temperature, preferably at a temperature of about 100° C. to about 300° C., to produce ammonium hydrogen sulfate for recycling to the process for reuse. The calcium carbonate is removed as waste.

In respect of the first and second embodiments described in detail herein, the following reactions are provided. The reactions are related to the matters described in the first and second embodiments.

(1) 2Ca₅F(PO₄)₃+6NH₄HSO₄+6H₂O→6CaHPO₄↓+3CaSO₄·2H₂O→+3(NH₄)₂SO₄+CaF₂↓;
(2) 6CaHPO₄+6NH₄HSO₄+12H₂O→6NH₄H₂PO₄+6CaSO₄·2H₂O↓;

### (3) 9CaSO₄·2H₂O+9(NH₄)₂CO₃→9(NH₄)₂SO₄+9CaCO₃↓+18H₂O;

### (4) 12(NH₄)₂SO₄→12NH₄HSO₄+12NH₃; or

### (5) 6(NH₄)₂SO₄+6H₂SO₄→12NH₄HSO₄.

The process described in the first and second embodiments of the invention are advantageous for many reasons. Several of the advantages are as follows:

(a) The mono-ammonium, sodium, or potassium phosphates produced by the first and second embodiments, are expected to have a high level of purity. As compared to mono-ammonium phosphate produced by a process utilizing wet process phosphoric acid and ammonia, the purity of the presently produced ammonium phosphate is expected to be higher since a weaker acidity of ammonium hydrogen sulfate is used, rather than sulfuric acid;

(b) No phosphoric acid recycle is required, as compared to a conventional wet process where it is necessary to recycle phosphoric acid through a reaction system. This is expected to increase the capacity of the reaction system;

(c) Ammonium, sodium, or potassium hydrogen sulfate is less corrosive than sulfuric acid. As a result, it is expected that less expensive protection for reactor vessels will be required;

(d) Gypsum production is reduced, and/or eliminated; and

(e) Fluorine in the process system of the first and second embodiments, precipitates as calcium fluoride. In a comparative process, the fluorine results in the formation of hydrofluoric acid, that is hazardous to handle, and the production of fluosilicic acid by-product.

(f) The end product of the present process is mono-ammonium, sodium, or potassium phosphate, without phosphoric acid being produced. In the conventional wet process for producing phosphates, phosphoric acid is produced prior to obtaining phosphate. As a result, a lower amount of sulfuric acid is required.

In a third embodiment, the present invention relates to another process for producing ammonium phosphate, sodium phosphate or potassium phosphate. In this embodiment, phosphate rock is reacted with ammonium, sodium, or potassium hydrogen sulfate, at any suitable temperature, preferably at a temperature ranging from about 20° C. to about 100° C., to produce a slurry comprising calcium phosphates, ammonium, sodium, or potassium sulfate, dihydrated calcium sulfate (gypsum), and calcium fluoride. The slurry is then reacted with sulfuric acid at any suitable temperature, preferably about 20° C. to about 100° C., whereby the sulfate in the slurry is converted to ammonium, sodium, or potassium hydrogen sulfate, and the calcium phosphates are converted by ammonium, sodium, or potassium hydrogen sulfate to mono-ammonium, sodium, or potassium phosphate and dihydrated calcium sulfate (gypsum). The mono-ammonium, sodium, or potassium phosphate is separated from the solids by any suitable means, preferably by filtration.

The solids remaining after the separation of the mono-ammonium, sodium, or potassium, phosphate is treated with ammonium, sodium, or potassium carbonate to convert the dihydrated calcium sulfate (gypsum) to ammonium, sodium, or potassium sulfate and calcium carbonate. The ammonium, sodium, or potassium sulfate may be separated from the calcium carbonate, and then reacted with sulfuric acid to produce ammonium, sodium, or potassium hydrogen sulfate for recycling to the process for reuse.

The mono-ammonium, sodium, or potassium phosphate produced in this embodiment is expected to have a high degree of purity. The mono-ammonium, sodium, or potassium, phosphate may be used as is or may be used as an intermediate in producing di-ammonium, sodium, or potassium phosphate or other phosphates.

In respect of the third embodiment described in detail herein, the following reactions are provided. The reactions are related to the matters described in the third embodiment.

(6) 2Ca₅F(PO₄)₃+6NH₄HSO₄+6H₂O→6CaHPO₄↓+3CaSO₄·2H₂O↓+3(NH₄)₂SO₄+CaF₂↓;
(7) 6CaHPO₄+3(NH₄)₂SO₄+3H₂SO₄+12H₂O→6NH₄H₂PO₄+6CaSO₄·2H₂O↓;
(8) 6CaHPO₄+6NH₄HSO₄+12H₂O→6NH₄H₂PO₄+6CaSO₄·2H₂O↓;

### (9) 9CaSO₄·2H₂O+9(NH₄)₂CO₃→9(NH₄)₂SO₄+9CaCO₃↓+18H₂O;

### (10) 6(Nh₄)₂SO₄→6NH₄SO₄+6NH₃; and

### (11) 3(NH₄)₂SO₄+3H₂SO₄→6NH₄HSO₄

The process described in the third embodiment of the invention is advantageous for many reasons. Several of the advantages are as follows:

(a) The mono-ammonium sodium, or potassium phosphate produced by the third embodiment is expected to have a high level of purity. As compared to mono-ammonium phosphate produced by a process utilizing wet process phosphoric acid and ammonia, the purity of the presently produced phosphate is expected to be higher since ammonium, sodium, or potassium hydrogen sulfate having a weaker acidity is used, rather than sulfuric acid;

(b) No phosphoric acid recycle is required, as compared to a conventional wet process where it is necessary to recycle phosphoric acid through a reaction system. This is expected to increase the capacity of the reaction system;

(c) Gypsum production is reduced;

(d) Fluorine in the process system of the third embodiment, precipitates as calcium fluoride. In a comparative process, the fluorine results in the formation of hydrofluoric acid, that is hazardous to handle, and the production of fluosilicic acid by-product; and

(e) The end product of the present process is mono-ammonium, sodium or potassium phosphate, without phosphoric acid being produced. In the conventional wet process for producing phosphates, phosphoric acid is produced prior to obtaining phosphate. As a result, a lower amount of sulfuric acid is required.

The foregoing has been a description of several illustrative embodiments of the present invention. The present invention is not to be limited in scope by the illustrative embodiments described which are intended as specific illustrations of individual aspects of the invention, and functionally equivalent methods and components are within the scope of the invention. Indeed, various modifications of the invention, in addition to those shown and described herein will become apparent to those skilled in the art from the foregoing description. Such modifications are intended to fall within the scope of the invention.

What is claimed is:

1. A process for producing a phosphate selected from the group consisting of ammonium phosphate, sodium phosphate and potassium phosphate comprising:
(a) reacting phosphate rock with a component selected from the group consisting of ammonium hydrogen sulfate, sodium hydrogen sulfate and potassium hydrogen sulfate, to produce a first slurry comprising calcium phosphates, dihydrated calcium sulfate, calcium fluoride and a sulfate selected from the group consisting of ammonium sulfate, sodium sulfate, and potassium sulfate,
(b) separating the sulfate from the first slurry, leaving a solid material, and
(c) reacting the solid material from which the sulfate has been separated, with an additional amount of the component, to produce the phosphate.

2. The process according to claim 1 wherein the phosphate is ammonium phosphate, and the component is ammonium hydrogen sulfate.

3. The process according to claim 1 wherein the phosphate rock is reacted with the component at a temperature ranging from about 20° C. to about 100° C., and the solid material is reacted with a additional amount of the component at a temperature ranging from about 20° C. to about 100° C.

4. The process according to claim 1 wherein the phosphate is produced in the form of a second slurry and is separated from the second slurry.

5. The process according to claim 4 wherein the second slurry, from which the phosphate has been separated, is further reacted with a carbonate selected from the group consisting of ammonium carbonate, sodium carbonate, and potassium carbonate, to produce a third slurry comprising sulfate and calcium carbonate from the dihydrated calcium sulfate.

6. The process according to claim 5 wherein the sulfate is further separated from the third slurry, and reacted with sulfuric acid to produce the component.

7. The process according to claim 5 wherein the sulfate that is produced is ammonium sulfate, that is further separated from the third slurry, and thermally decomposed to produce the ammonium hydrogen sulfate.

8. A process for producing a phosphate selected from the group consisting of ammonium phosphate, sodium phosphate and potassium phosphate comprising:
(a) reacting phosphate rock with a component selected from the group consisting of ammonium hydrogen sulfate, sodium hydrogen sulfate and potassium hydrogen sulfate, to produce a first slurry comprising calcium phosphates, dihydrated calcium sulfate, calcium fluoride, and a sulfate selected from the group consisting of ammonium sulfate, sodium sulfate, and potassium sulfate, and
(b) reacting the first slurry with sulfuric acid to produce a second slurry comprising the phosphate and dihydrated calcium sulfate.

9. The process according to claim 8 wherein the phosphate is ammonium phosphate, and the component is ammonium hydrogen sulfate.

10. The process according to claim 8 wherein the phosphate rock is reacted with the component at a temperature ranging from about 20° C. to about 100° C., and the first slurry is reacted with sulfuric acid at a temperature ranging from about 20° C. to about 100° C.

11. The process according to claim 8 wherein the phosphate is separated from the second slurry.

12. The process according to claim 11 wherein the second slurry from which the phosphate has been separated, is further reacted with a carbonate selected from the group consisting of ammonium carbonate, sodium carbonate, and potassium carbonate, to produce a third slurry comprising sulfate and calcium carbonate from the dihydrated calcium sulfate.

13. The process according to claim 12 wherein the sulfate is further separated from the third slurry, and reacted with sulfuric acid to produce the component.

14. The process according to claim 12 wherein the sulfate that is produced is ammonium sulfate which is further separated from the third slurry, and thermally decomposed to ammonium hydrogen sulfate.
